(19) United States
(12) Patent Application Publication
(10) Pub. No.: US 2002/0064753 A1
(43) Pub. Date: May 30, 2002

(54) Thermoplastic dispenser, and method of using such, particularly suited for dental work, and system including dental ipression tray

(76) Inventor: Graham K. Philp JR., Palm Harbor, FL (US)

Correspondence Address: SHLESINGER, ARKWRIGHT & GARVEY LLP, 3000 SOUTH EADS STREET, ARLINGTON, VA, 22202, US

(21) Appl. No.: 09/921,306

(22) Filed: Aug. 3, 2001

Related U.S. Application Data
(60) Provisional application No. 60/223,034, filed on Aug. 4, 2000.

(51) Int. Cl. A61C 3/00; A61C 9/00

(52) U.S. Cl. 433/32; 433/37; 433/71; 433/89

(57) ABSTRACT

Dispenser is disclosed. Method of dispensing dental material includes the provision of a dental tool, a dental tray, which may be a dental impression tray, as well as a bite tray. The bite tray may be provided with strands extending between first and second sides of the tray. In use, a material may be provided on the strands to cover the strands at least in part. The strands may be selected and located relative to each other so that, in use, when a user's teeth exert force on or contact one or more of the strands the respective strands move relative to each other, and move without exerting sufficient force on the first side of the dental tray so as to cause the first side of the dental tray to move relative to the second side of the dental tray.

### CROSS REFERENCE TO RELATED APPLICATION

This application claims the priority of U.S. Provisional Application No. 60/223,034, filed Aug. 4, 2000, which is incorporated herein by reference.

### FIELD OF THE INVENTION

The invention relates to a dispenser and a method of using such. More particularly, the invention relates to a thermoplastic dispenser and a method of using the same. Even more particularly, the invention relates to a thermoplastic dispenser for dispensing thermoplastic in a softened, usable state, and a method of using such, such as with a dental impression tray.

This dispenser would have applications in the dental field, as well as in any other commercial, medical, or private use.

### BACKGROUND OF THE INVENTION

The use of thermoplastics in the field of dentistry is known.

Conventionally, hardened or semi-hardened thermoplastics are used in the making of dental impressions, for example.

Thermoplastics are also used as material to build up regions of castings that serve as the basis for making dentures.

In order to melt or soften thermoplastics in the conventional dental office or laboratory, a dedicated water bath, which may be a so-called crock pot, such as found in the domestic kitchens, has been used to soften the thermoplastic. Alternatively, it has been known to heat up a cup of water in a microwave oven to a temperature of 150° F. or more, and then carry the hot cup of water into the room where the dentist or technician is working the thermoplastic material.

Currently in the dental field thermoplastic is typically used in the form of pre-formed wafers, such as so-called TEMP-TABS™ which are heated in use.

There is also known thermoplastic which is incorporated in a triple tray or dental impression tray, such as a so-called THERMO-TRAY™.

Both the TEMP-TABS™ and the THERMO-TRAY™ must be softened in hot water, as discussed above.

This heating in the dental office not only leads to the problems discussed above, but if the thermoplastic is improperly or overheated, it may develop undesirable bubbles in the overheated thermoplastic. Further, the TEMP-TABS™ are very costly and, even if a relatively small quantity of TEMP-TABS™ are required for a procedure, such may be cost prohibitive.

Unformed thermoplastic is a relatively inexpensive material.

Needless to say, such prior art devices and methods of heating and using heated thermoplastic material are impractical, if not unwieldy.

Still further, prior art dental impression trays are known, such as shown in U.S. Pat. No. 4,619,610 to Pelerin, which is incorporated herein by reference for its description of its FIGS. 1-5, set forth herein as PRIOR ART FIGS. 1-5, and which discloses the use of a conventional dental impression tray.

Pelerin '610 describes a dental impression tray DIT, having a rigid material RM on one side thereof, and an impression material IM on another side thereon. A known gauze G extends across the width of dental impression tray DIT. In an attempt to prevent distortion of the dental tray DIT first cross braces CB1 are integrally formed with the side wall.

Flexing of the side wall is undesirable because such leads to a distortion of the impression of the patient's tooth which is pressed into the impression material IM in use.

Pelerin provided a second cross brace CB2 which may be secured to the side wall as shown in prior art FIG. 4, and as described in Pelerin '610. Drawbacks of Pelerin '610 remain.

The practitioner must locate cross brace CB2 so that it does not interfere with the process of making an impression.

Further, the practitioner must contend with the unavoidable drawback that Pelerin gauze G distorts when the patient's teeth press down upon it. The gauze G distorts because the gauze, which in practice is produced as a mesh having open holes therethrough, is made of a series of elements extending in a first direction and a second series of longitudinal elements extending in a second direction perpendicular to the first direction. Thus, the pressure exerted by the patient's teeth cause distortion of the impression material as well as the sides of the tray DIT.

And, as discussed above, trays such as the Pelerin tray tend to be relatively expensive.

A known method of making a custom impression tray is shown in U.S. Pat. No. 5,213,498 to Pelerin.

Accordingly, there is a need for a device or method of using such device that overcomes the drawbacks of conventional devices.

### OBJECTS AND SUMMARY OF THE INVENTION

It is an object of the invention to provide a thermoplastic heating device and method of using such that overcome the drawbacks of the prior art.

Another object of the invention is to provide a thermoplastic heating device which is easier to use, more wieldy, and which accurately heats thermoplastic material, as compared with prior art devices and methods.

A still further object of the invention is to provide a thermoplastic heating device and a method of using the same.

Yet another object of the invention is to provide a combined thermoplastic dispenser and water bath.

A further object of the invention is to provide a thermoplastic dispenser which accurately dispenses controllable amounts of preheated thermoplastic material.

Yet another object of the invention is to provide a dental impression tray and method of making such which overcomes the drawbacks of prior art trays.

Yet another object of the invention is to provide a dental impression tray which yields distortion free impressions of teeth, in use.

Yet anther object of the invention is to provide a dental impression tray which is easier and less expensive to use, and is more versatile than prior art devices.

A still further object of the invention is to provide a dental impression system which incorporates the features above.

These and other objects have been achieved, as evidenced by the following.

The inventive device includes a dispenser for retaining and dispensing a first material; and a reservoir disposed adjacent the dispenser, the reservoir being configured for retaining a second type of material. A heater may be provided for heating a first material retained in the dispenser.

A method of dispensing a dental material including the steps of providing a dispenser for retaining and dispensing a first material, the first material being a dental material; and providing a heater for heating a first material retained in the dispenser, the heater being provided adjacent the dispenser.

A method of making a bite tray includes the steps of:

a) providing an empty bite tray having a first side, a second side, and strands extending between a first side and a second side;

b) providing a softened material; and

c) covering the strands at least in part with the softened material.

A method of making a bite tray, includes the steps of:

a) providing an empty bite tray having a first side, a second side, and strands extending between a first side and a second side;

b) providing a solid material;

c) covering the strands at least in part with the softened material; and

d) the step of covering the strands includes laying the solid material on an upper surface of the strands.

A dental tray according to the invention includes:

a) a first side and a spaced apart second side; and

b) a plurality of strands extending between the first and second sides.

A dental tray system according to the invention includes:

a) a tray including a first side and a spaced apart second side;

b) a plurality of strands extending between the first and second sides; and

c) a solid piece of dental material being disposed on said plurality of strands.

### BRIEF DESCRIPTION OF THE DRAWINGS

FIGS. 1-5 illustrate a prior art dental impression tray DIT, such as shown in U.S. Pat. No. 4,619,610 to Pelerin;

FIG. 6 illustrates a first preferred embodiment of a dental impression tray according to the invention;

FIG. 7 illustrates another preferred embodiment of a dental impression tray according to the invention;

FIG. 8 illustrates another preferred embodiment of a dental impression tray according to the invention;

FIG. 9 illustrates a still further preferred embodiment of a dental impression tray according to the invention;

FIG. 10 illustrates a strand forming part of a yet still further preferred embodiment of a dental impression tray according to the invention;

FIG. 11 illustrates a pre-hardened thermoplastic insert according to the invention;

FIG. 12 illustrates a PRIOR ART double arch triple tray-NEO TRAY™;

FIG. 13 illustrates a TEMP-TAB™ over a tooth to be prepared and an inventive thermoplastic insert on opposing side;

FIG. 14 illustrates a PRIOR ART TEMP-TAB″;

FIGS. 15-17 show three different embodiments of thermoplastic dispensers according to the invention.

Relative terms, such as up, down, left, and right are for convenience only and are not intended to be limiting.

### DETAILED DESCRIPTION OF THE INVENTION

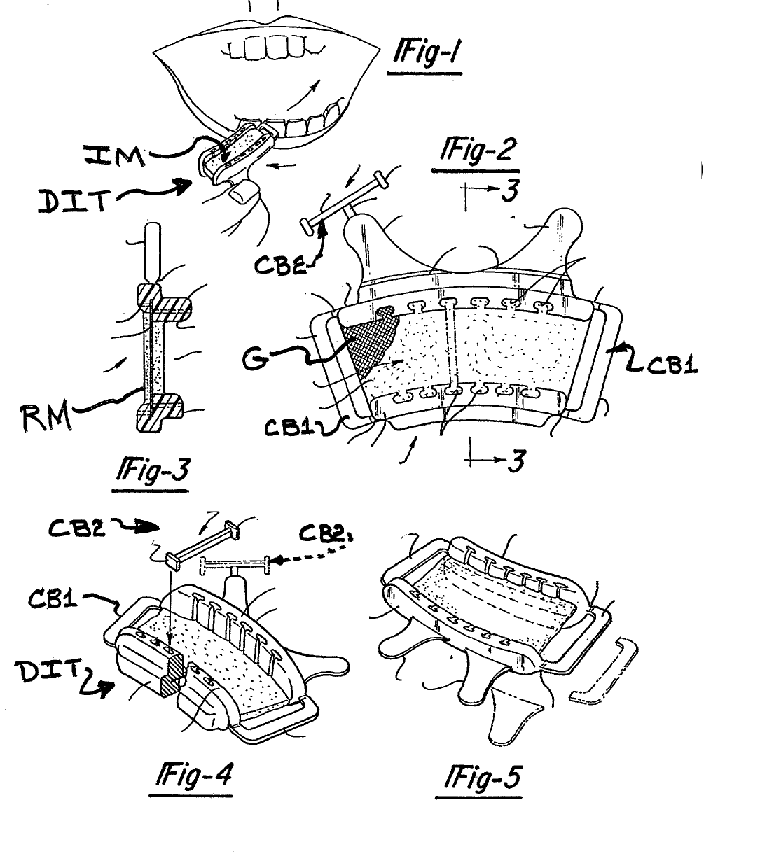

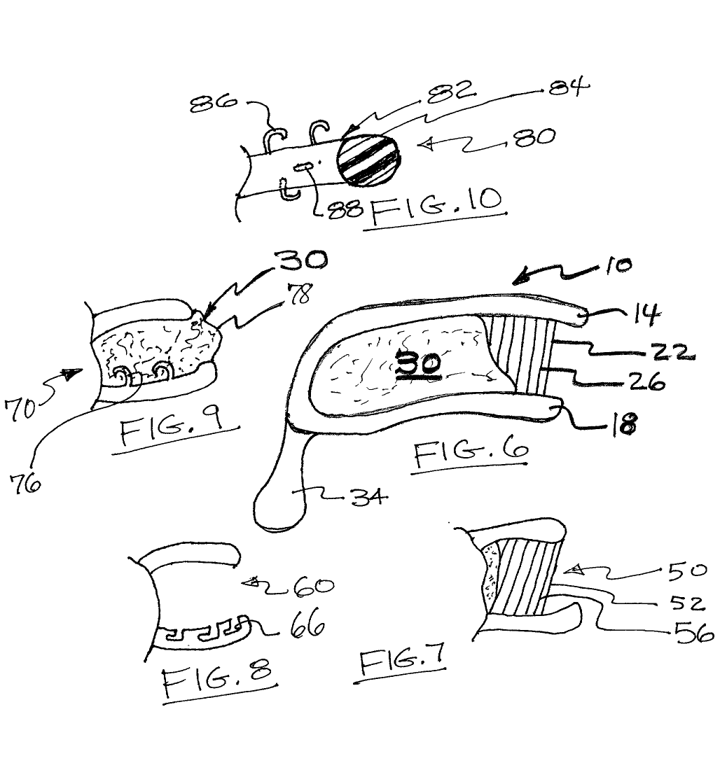

FIGS. 1-5 illustrate a PRIOR ART device, as described above.

FIG. 6 illustrates a first preferred embodiment of a dental impression tray or tray 10.

Tray 10 includes a first side 14 and a second side 18 spaced apart therefrom. First and second sides 14 and 18 may be integrally joined at one end thereof.

One or more strands 22 and 26 may extend between sides 14 and 18. Strands 22 and 26 may be made of a synthetic material. The synthetic material may selected for its affinity (i.e., propensity to bond with) a dental impression material 30 disposed on strands 22 and 26.

Strands 22 and 26 may be free of linking members (other than first and second sides) which extend between strand 22 and 26. In that manner when a patient's teeth bite down on impression material 30 and, hence, strands 22 and 26 disposed thereunder or therein, strands 22 and 26 will move toward or away from each other depending on the location of the portion of the patient's tooth exerting pressure on a portion of the strand.

Unlike PRIOR ART devices, such as described in connection with FIGS. 1-5 above, the length, size, spacing, and material of strands 22 and 26 may be selected so that under pressure from a patent's tooth, in use, there will be little or no tendency for first side 14 to move relative to second side 18. In other words, sides 14 and 18 will not distort, thus causing the impression material 30 to distort.

In known dental impression trays, there is a tendency for the opposing sides to move toward each other under pressure, and then “spring back” after the pressure is released, thereby distorting the impression of the patient's tooth that was made in the impression material.

A handle 34 for assisting in the manipulation of tray 10 may be provided.

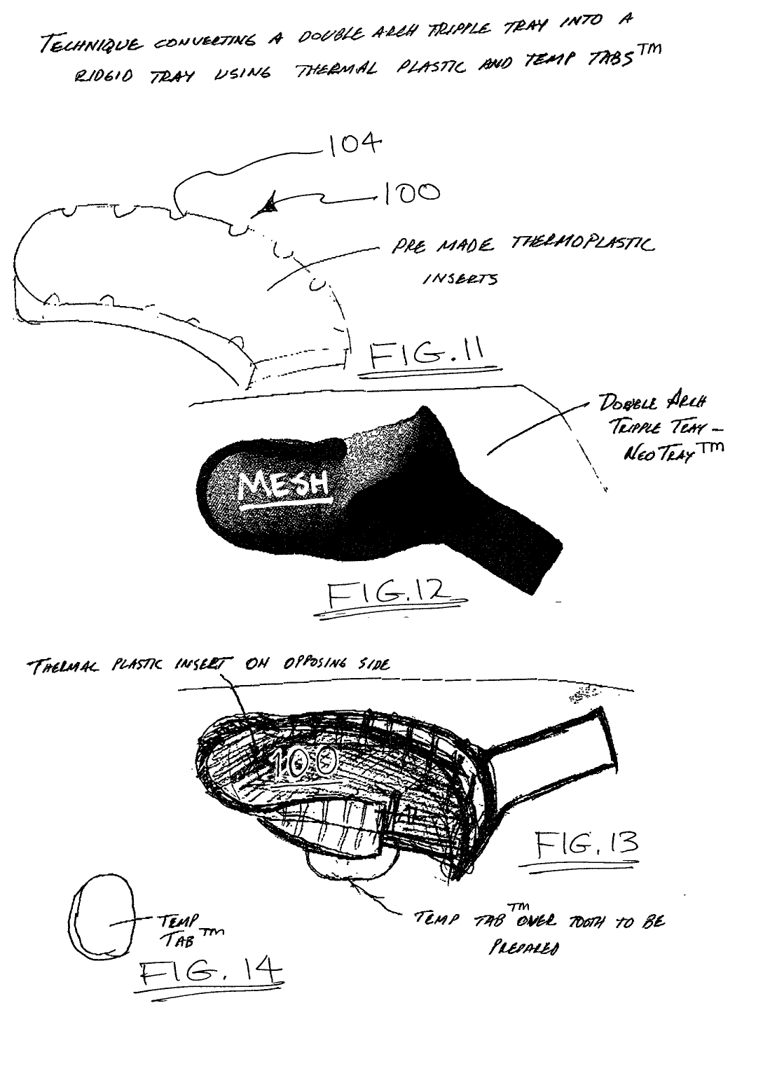

FIG. 7 illustrates a further preferred embodiment of a portion of a dental impression tray 50. Tray 50 includes strands 52 and 56 which extend at a greater angle relative to the sides to which they are attached, as compared with the angle defined by strands 22 and 26 of tray 10 of FIG. 6.

FIG. 8 illustrates a further preferred embodiment of a tray 60. Tray 60 includes hook-like openings 66 in at least one of its side walls. Hook like opening 66 are configured for receiving impression material 30 wherein when material 30 is in a softened and hardened state, to assist in retaining the impression material within the tray and relative to the side, for example.

FIG. 9 illustrates a further preferred embodiment of a tray 70 according to the invention. Tray 70 includes one or more hook like elements 76 extending outwardly away from one or more of the sides of the tray. Hook like elements 76 are configured for engaging impression material 30. FIG. 9 shows that, in use, extra impression material may be added in a region 78 outwardly of the free ends of the sides of tray 70. In that manner, the rigidity and distortion-free properties of tray 70, as well as other trays according to the invention described herein may be enhanced.

FIG. 10 illustrates yet another preferred embodiment of a portion of a tray 80 according to the invention. In tray 80, only a single strand 82 of which is illustrated for clarity, strand 82 itself may be provided with one or more hooks 86 and 88.

Hooks 86 and 88 may all extend outwardly away from the main body 84 of strand 82 at a common angle and orientation, or hooks 86 and 88 may be provided at various locations and extending at various angles and heights, relative to main body 84, as shown.

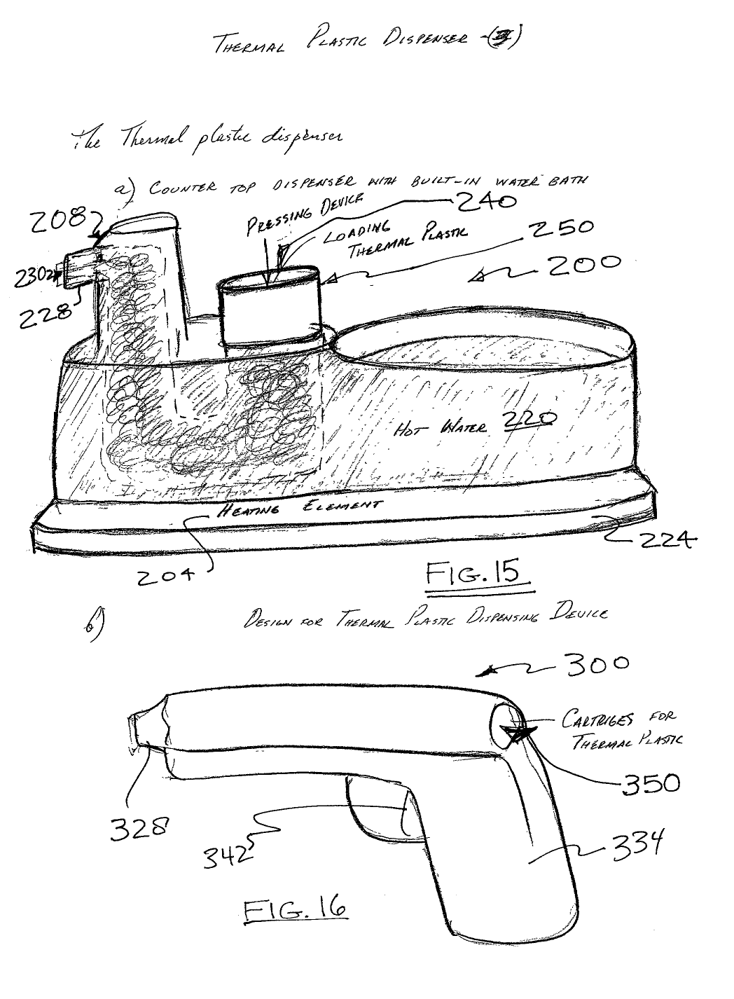

FIG. 11 illustrates a premade thermoplastic insert 100 which may be used for converting a double arch triple tray into a rigid tray. By use of the novel premade insert 100 the dental impression tray can be completed on-site (e.g., in the dental practitioner's office) immediately prior to obtaining an impression of a patient's teeth in a less expensive and a more accurate manner than by using the prior art devices.

FIG. 12 illustrates a PRIOR ART double arch triple tray such as a so-called NEO TRAY™.

FIG. 13 illustrates the inventive thermoplastic insert 100 in use with the tray of FIG. 12.

One or more notches 104 provided in thermoplastic insert 100 may be selected to mate with respective prior art extensions on the prior art triple tray. After the dental practitioner places the insert 100 into an existing triple tray, for example, such would be placed in a water bath to heat up the insert 100 sufficiently, so that when the combination is removed from the water bath, the rehardening material provided by insert 100 will engage with the triple tray and be ready for use.

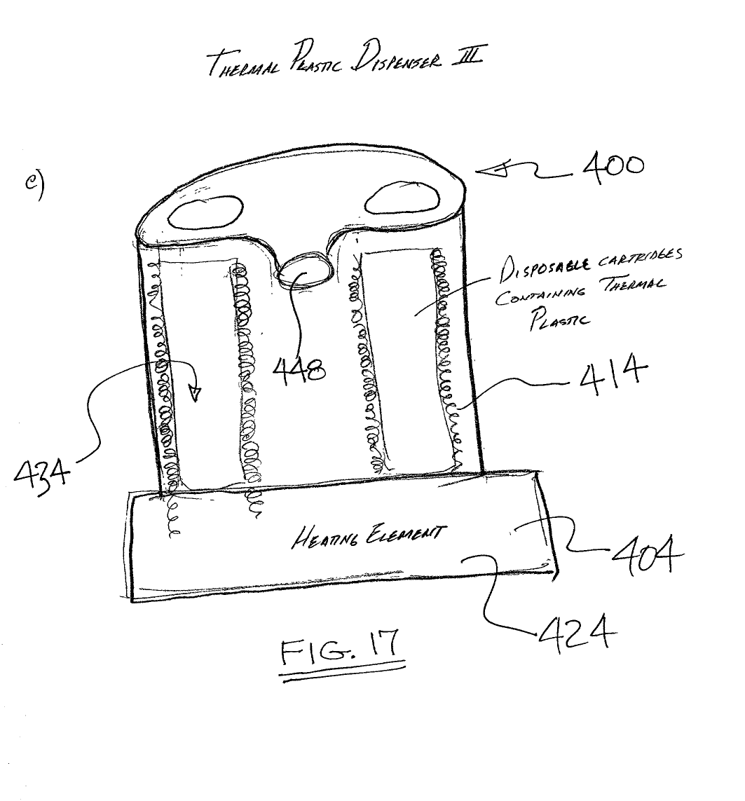

FIG. 14 illustrates a TEMP TAB™ wafer.

Use of the thermoplastic inserts is as follows.

The thermoplastic inserts 100 may be premade to fit into various known dental impression trays, such as NEO TRAYS™ and MULTI TRAYS. Inserts 100 may be placed into the tray of FIG. 12 so that the thermoplastic insert is on the opposing side of the tooth to be prepared, as shown in FIG. 13. The tray has then placed in a water bath to soften the thermoplastic as well as a known TEMP TAB™.

The softened TEMP TAB™ is then adapted over the tooth to be prepared making an impression of the tooth after build-up prior to preparation, as in FIG. 13. Before the temp tab hardens, the tray with the softened thermoplastic insert 100 is placed on the opposing arch pressing it against the opposing occlusal surfaces making an impression of these surfaces into the thermoplastic. The patient is then guided into maximum intercuspation and asked to hold the teeth together in occlusion until the thermoplastic completely hardens, fusing the TEMP TAB™ and the opposing thermoplastic together.

This techniques converts a regular FIG. 12 arch triple tray into a tray which is rigid and cannot flex and thereby preventing spring back distortion which is a common problem with conventional triple trays. Further, the TEMP TAB™ on the prepared side over the tooth to be prepared acts as a vehicle to drive the wash impression material as well as a matrix to make a temporary.

The advantages of the tray in conjunction with insert 100 over the known thermo trays is the cost-effectiveness of the insert 100 and the TEMP TABS™. The current thermo tray is very small and only covers a small portion of the arch. The regular triple trays go around the arch making a larger impression making it easier to mount the cast, when one step mounting systems are not used. Also, the TEMP TABS™ incorporated into the tray will serve as a matrix to fabricate a temporary as well as a vehicle to drive the wash impression material assuring a good impression of the margins and prepared tooth without risking pulls or voids.

### FIGS. 15-17

FIGS. 15-17 illustrate several preferred embodiments of thermoplastic or thermal plastic dispensers according to the invention.

FIG. 15 illustrates a first preferred embodiment of a thermoplastic dispenser 200. Dispenser 200 may include a heating element 204, a dispenser 208 and a water bath 220. Water bath 220 may be disposed substantially adjacent to 208 and provided on a common base 224, as illustrated. A dispenser nozzle 228 may be provided and sized for general laboratory use or specifically sized for dispensing a thermoplastic material 230 onto a dental impression tray 10 of FIG. 6, for example.

Thermoplastic material 230 may be dispensed in a molten or semi-molten state by pressing on an actuator portion or pressing device 240 operatively connected with dispensable material 230. An integral or removable loading element 250 may be provided for ease of filling dispenser 200 with thermoplastic material to be dispensed. As shown, thermoplastic material may be provided in various degrees of softness or liquefaction in a region fluidly connecting dispenser 228 and actuator 240.

FIG. 16 illustrates another preferred embodiment of a dispenser 300 according to the invention. Dispenser 300 may include a nozzle 328 and a handle 334. An actuator or trigger 342 may be configured for being pressed by the user's finger or fingers. As in the embodiment of FIG. 15, a region 350 may be provided in which thermoplastic material is loaded for being softened or liquified. Loading region 350 may be sized for receiving cartridges of thermoplastic material.

FIG. 17 illustrates a yet still further preferred embodiment of a thermoplastic dispenser 400.

Dispenser 400 may be a free-standing device, in a manner analogous to dispenser 200 of FIG. 15.

Yet, dispenser 400 may be configured as a relatively tall dispenser, similar to the shape of known upright, free standing toothpaste dispensers.

Dispenser 400 may be provided with a heating element 404 including heating coils or thermally conductive elements 414 and a base 424.

One or more chambers 434 may be provided in which, for example, cartridges of thermoplastic material or thermoplastic stock may be provided. A dispenser nozzle 448 will be provided along the lines as discussed above, as well as an actuator for causing thermoplastic material to be dispensed.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A device, comprising:
a) a dispenser for retaining and dispensing a first material;
b) a reservoir disposed adjacent said dispenser, said reservoir being configured for retaining a second type of material; and
c) a heater provided for heating a first material retained in said dispenser.

2. A device as in claim 1, wherein:
a) said heater is disposed for heating a second material retained in said reservoir.

3. A device as in claim 2, wherein:
a) said reservoir is fluid reservoir.

4. A device as in claim 3, wherein:
a) said fluid reservoir is an open water bath.

5. A device as in claim 4, wherein:
a) said dispenser is configured for retaining a thermoplastic.

6. A device as in claim 4, wherein:
a) said dispenser includes a nozzle and an actuator for causing a first material retained in said dispenser to exit said nozzle.

7. A device as in claim 1, wherein:
a) a base is provided;
b) said heater is disposed on said base;
c) said dispenser and said reservoir are mounted on said base; and
d) said heater is located and configured for heating said reservoir.

8. A device as in claim 3, wherein:
a) a lid is provided on said fluid reservoir.

9. A device as in claim 6, wherein:
a) said nozzle includes a material sufficiently thermoconductive to ensure that a first material dispensed therethrough remains fluid within said nozzle.

10. A device as in claim 9, wherein:
a) said nozzle includes brass.

11. A device as in claim 6, wherein:
a) said nozzle is configured to ensure that a first material dispensed therethrough remains fluid within said nozzle.

12. A device as in claim 1, wherein:
a) said dispenser is configured for retaining a thermoplastic; and
b) said water bath is sized for receiving a dental tool therein.

13. A device as in claim 7, wherein:
a) said base includes a support surface, and said support surface is sufficiently large so it can rest on a flat support surface and support the remainder of the dispenser, while the dispenser is being operated.

14. A device as in claim 2, wherein:
a) a removable liner is provided in said reservoir.

15. A method of dispensing a dental material, comprising:
a) providing a dispenser for retaining and dispensing a first material, said first material being a dental material; and
b) providing a heater for heating a first material retained in said dispenser, said heater being provided adjacent said dispenser.

16. A method as in claim 15, further comprising the step of:
a) providing a dental tool; and
b) dispensing a dental material from the dispenser onto the dental tool.

17. A method as in claim 16, wherein:
a) in said step of dispensing dental material onto a dental tool, the dental material includes a thermoplastic.

18. A method as in claim 17, wherein:
a) in said step of providing a dental tool, the dental tool includes a spatula.

19. A method as in claim 18, wherein:
a) in said step of providing a dental tool, the dental tool includes a dental tray.

20. A method as in claim 19, wherein:
a) said tray is a dental impression tray.

21. A method as in claim 20, wherein:
a) said dental impression tray is a triple tray.

22. A method as in claim 16, wherein:
a) said dispenser includes a hand-held dispenser including a trigger, said trigger being operatively attached for dispensing a first material disposed in said dispenser, and said trigger being operable by at least one portion of a user's hand.

23. A method as in claim 16, wherein:
a) said dispenser includes a free-standing base;
b) an actuator is provided; and
c) said actuator is operatively attached to said dispenser for dispensing a first material from said dispenser, and said actuator is operable by at least one of a portion of a user's body and an object operated by a user.

24. A method of making a bite tray, comprising:
a) providing an empty bite tray having a first side, a second side, and strands extending between the first side and the second side;
b) providing a softened material; and
c) covering the strands at least in part with the softened material.

25. A method as in claim 24, further comprising the steps of:
a) using the at least partially filled bite tray to make a dental impression.

26. A method as in claim 24, wherein:
a) the material includes a dental wax.

27. A method as in claim 24, wherein:
a) the strands include a protrusion extending transversely therefrom, the protrusion being configured for engaging with the softened material at least when the softened material is in a hardened state.

28. A method as in claim 24, wherein:
a) the protrusion includes hooks extending transversely relative to said strands.

29. A method as in claim 24, further comprising the step of:
a) providing a further material on the strands, the further material being selected to enhance the adhesion between the strands and the softened material.

30. A method as in claim 29, wherein:
a) the further material includes a coating.

31. A method as in claim 27, wherein:
a) the strands are contained substantially within a common plane;
b) the first side extends transversely relative to the common plane; and
c) at least one of a further protrusion and an indentation are provided on said first side, each one of said further protrusion and said indentation is configured for engaging said softened material.

32. A method of making a bite tray, comprising:
a) providing an empty bite tray having a first side, a second side, and strands extending between the first side and the second side;
b) providing a solid material;
c) covering the strands at least in part with the softened material; and
d) said step of covering the strands includes laying the solid material on an upper surface of the strands.

33. A method as in claim 32, wherein:
a) said first side includes a material selected for its chemical affinity to said softened material.

34. A method as in claim 32, wherein:
a) said empty tray is provided by a manufacturer;
b) said softened material is provided by a dental practitioner.

35. A method as in claim 34, wherein:
a) said softened material is provided by a dental practitioner by placing a solid piece of material in said empty bite tray on the strands, and then softening the solid piece of material to yield the softened material.

36. A method as in claim 35, wherein:
a) said piece of solid material has a shape that substantially corresponds to a shape defined between the first side and the second side of the empty tray.

37. A dental tray, comprising:
a) a first side and a spaced apart second side; and
b) a plurality of strands extending between said first and second sides.

38. A dental tray as in claim 37, wherein:
a) each of said plurality of strands is configured and spaced relative to each other so that, in use, when a user's teeth exert force on or contact one or more of the plurality of strands the respective strands move relative to each other, and move without exerting sufficient force on said first side so as to cause said first side to more relative to said second side.

39. A dental tray system, comprising:
a) a tray including a first side and a spaced apart second side;
b) a plurality of strands extending between said first and second sides; and
c) a piece of dental material configured to substantially extend between the first and second sides, the solid piece of material being disposable on said plurality of strands.

40. A system as in claim 39, wherein:
a) said piece of material comprises a thermoplastic.

41. A system as in claim 39, wherein:
a) said piece of material comprises an insert.

42. A system as in claim 40, wherein:
a) the thermoplastic rests on said plurality of strands.

43. A system as in claim 40, wherein:
a) said plurality of strands is substantially free of a transversely extending element linking adjacent ones of said plurality of strands.

44. A system as in claim 40, wherein:
a) a protrusion configured for engaging the dental material when the dental material is softened is provided on one of said plurality of strands.

45. A system as in claim 44, wherein:
a) said protrusion includes a fishhook-like element.

46. A system as in claim 39, wherein:
a) said plurality of strands includes a synthetic material; and
b) said piece of dental material includes a thermoplastic.
